(19) United States
(12) Patent Application Publication
(10) Pub. No.: US 2021/0179057 A1
(43) Pub. Date: Jun. 17, 2021

(54) DRIVING ASSIST SYSTEM, VEHICLE WITH SELF-DRIVING CAPABILITY, AND DRIVING ASSIST METHOD

(71) Applicant: HONDA MOTOR CO., LTD., Tokyo (JP)

(72) Inventors: Yuhei SHINGAI, Wako-shi (JP); Yuki NAKADA, Wako-shi (JP); Masaaki KAWANO, Wako-shi (JP); Yasushi SHODA, Wako-shi (JP); Daisuke HANZAWA, Wako-shi (JP)

(21) Appl. No.: 17/118,721

(22) Filed: Dec. 11, 2020

(30) Foreign Application Priority Data
Dec. 13, 2019 (JP) 2019-225953

(51) Int. Cl. B60W 10/18; G05D 1/02; B60W 10/04; B60W 10/20

(52) U.S. Cl. CPC B60W 10/18; G05D 1/021; B60W 10/04; B60W 10/20; B60W 2540/215; B60W 2710/20; B60W 2510/18; B60W 2552/15; B60W 2520/06; B60W 2710/182

(57) ABSTRACT

An automated-parking control unit prevents a brake noise during braking, when causing a vehicle to start moving forward or backward. The automated-parking control unit includes: an environment recognizer to recognize environment of a vehicle; a behavior controller to execute behavior control inclusive of steering and acceleration/deceleration, based on recognized information; a brake hold instructor to suspend the vehicle with the behavior control and hold the suspension until receiving behavior-related operation by a driver; and a brake fluid pressure controller, when the vehicle is made to start moving forward or backward, to estimate a range having a brake noise and increase a change rate of a brake fluid pressure in a brake-noise range having a brake noise, as compared with that in a no-brake-noise range.

### CROSS-REFERENCE TO RELATED APPLICATION

This application claims the benefit of priority to Japanese Patent Application No. 2019-225953 filed on 13 Dec. 2019, the disclosures of all of which are hereby incorporated by reference in their entireties.

### TECHNICAL FIELD

The present invention relates to a driving assist system, a vehicle with driving capability, and a driving assist method.

### BACKGROUND OF THE INVENTION

Japanese Patent Application Publication No. 2017-065539 (hereinafter, referred to as Patent Document 1) discloses a vehicular stop control apparatus to vary a rate of reducing a braking force for a wheel so that the rate of reducing the braking force after a time point, at which a predetermined time has elapsed since reducing the braking force has been started, is smaller than that before the time point. The device disclosed in Patent Document 1 has a brake fluid pressure increased, when the shifter is in a D-range and the vehicle is retained in suspension, and then gradually decreased when the shifter has been shifted into a P-range, to reduce shock from a swing-over.

Japanese Patent No. 5834058 (hereinafter, referred to as Patent Document 2) discloses a parking assist ECU to execute parking assist control capable of recognizing environment of a vehicle by a camera and then guiding the vehicle to a desired parking position.

### SUMMARY OF THE INVENTION

### Problems to be Solved

However, the vehicular stop control device of Patent Document 1 has not taken noisemaking when a vehicle is braked (brake noise) into consideration. That is, a brake pad is pressed against a disk by oil pressure, when a vehicle is braked. At this time, a brake noise may be made, depending on balance between a frictional force generated by the brake pad and a driving force. A brake noise is made when the brake pad is separated off the disk after being pressed against the disk. This brake noise brings uncomfortable feeling or discomfort to a driver.

Particularly when the vehicle is braked in automated steering with parking assist control of Patent Document 2, a driver may feel a brake noise sensitively more than normal because automated steering is being executed. AU the more in a case where the vehicle is an EV (Electric Vehicle), which is superior in quietness, or the like, a brake noise during braking notably brings uncomfortable feeling or discomfort to a driver,

The present invention has been made in view of above-identified problems and is intended to provide a driving assist system, a vehicle with self-driving capability, and a driving assist method to prevent a brake noise during braking, when a vehicle is made to start moving forward or backward.

### Solution to Problem

A driving assist system of the present invention solves the above-identified problems, and includes: an environment recognizer to recognize environment of a vehicle; a behavior controller to execute behavior control inclusive of steering and acceleration/deceleration, based on recognized information; a suspension hold controller to suspend the vehicle with the behavior control and hold the vehicle suspended until receiving behavior-related operation by a driver; and a brake fluid pressure controller to increase or decrease a brake fluid pressure as a braking force for a wheel, wherein the brake fluid pressure controller, when the vehicle is made to start moving forward or backward, estimates a range having a brake noise and increases a change rate of the brake fluid pressure in a brake-noise range having a brake noise as compared with that in a no-brake-noise range.

### Advantageous Effects of the Invention

The present invention prevents a brake noise during braking, when the vehicle is made to start moving forward or backward.

### BRIEF DESCRIPTION OF DRAWINGS

FIG. 1 is a block diagram of a system configuration, centered around an automated-parking control unit according to an embodiment of the present invention;

FIG. 2 is a top view of a vehicle mounted with the automated-parking control unit according to the embodiment of the present invention, to show mounting positions of cameras and sonars;

FIG. 3 shows a disk brake of the vehicle mounted with the automated-parking control unit according to the embodiment of the present invention;

FIG. 4A is a top view of a parking area, to show the vehicle, mounted with the automated-parking control unit according to the embodiment of the present invention, in search of a space for parking;

FIG. 4B is a top view of the parking area, to show the vehicle, mounted with the automated-parking control unit according to the embodiment of the present invention, in search of a space for parking;

FIG. 4C is a top view of the parking area, to show the vehicle, mounted with the automated-parking control unit according to the embodiment of the present invention, in search of a space for parking;

FIG. 5 shows a flowchart of a process executed by the automated-parking control unit according to the embodiment of the present invention;

FIG. 6 shows a flowchart of a process executed by the automated-parking control unit according to the embodiment of the present invention;

FIG. 7 is a top view of the parking area, to illustrate processing executed by the automated-parking control unit according to the embodiment of the present invention;

FIG. 8 is a top view of the parking area, to illustrate processing executed by the automated-parking control unit according to the embodiment of the present invention;

FIG. 9 is a top view of the parking area, to illustrate processing executed by the automated-parking control unit according to the embodiment of the present invention;

FIG. 10 is a top view of the parking area, to illustrate processing executed by the automated-parking control unit according to the embodiment of the present invention;

FIG. 11 is a plan view of a selection screen displayed on a touch panel through processing by the automated-parking control unit according to the embodiment of the present invention;

FIG. 12 is a top view of the parking area, to illustrate the brake fluid pressure control for braking, when the vehicle is made to start moving forward or backward, by the brake fluid pressure controller of the automated-parking control unit according to the embodiment of the present invention;

FIG. 13 is a chart showing a relationship between a brake-noise range/a no-brake-noise range and a gradient of a rate of reducing the brake fluid pressure, with the automated-parking control unit according to the embodiment of the present invention; and

FIG. 14 is a flowchart of the brake fluid pressure control for braking, when the vehicle is made to start moving forward or backward, by the brake fluid pressure controller of the automated-parking control unit according to the embodiment of the present invention.

### EMBODIMENTS OF THE INVENTION

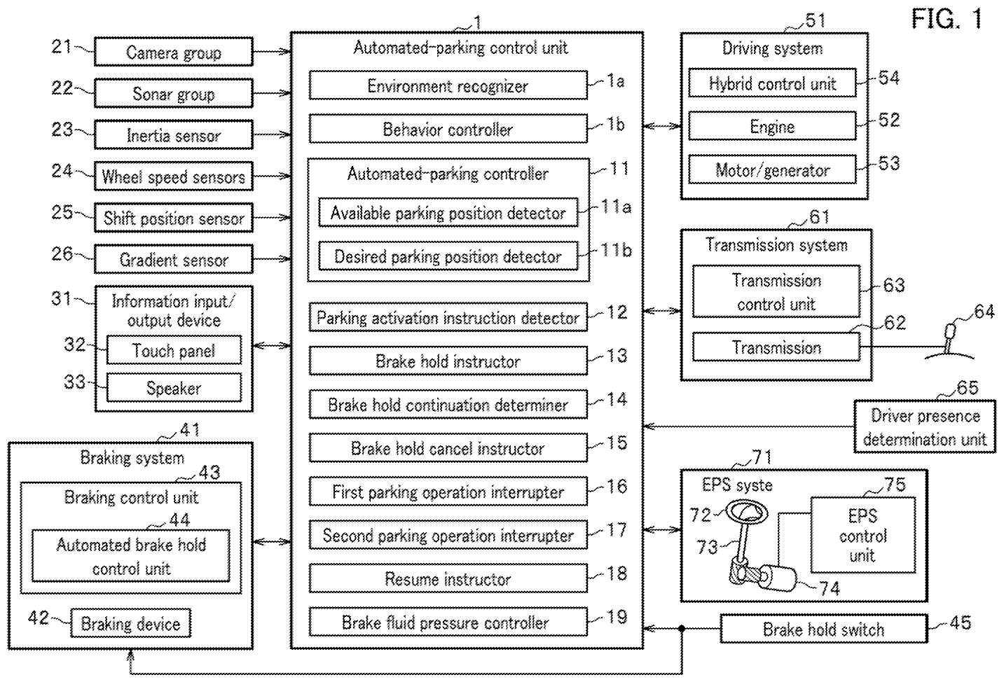

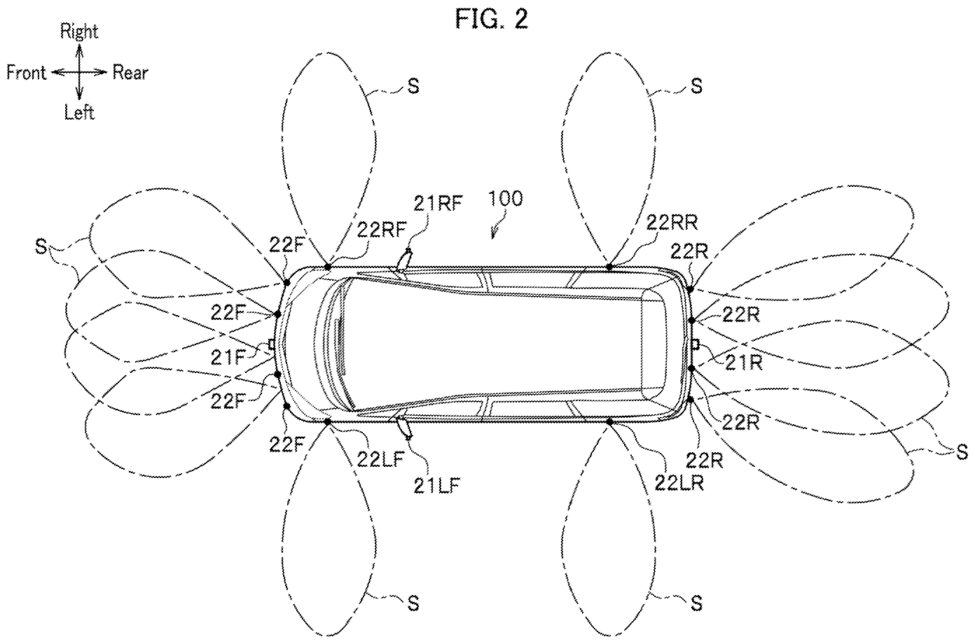

Hereinafter, an embodiment of the present invention is described with reference to drawings. Directions of front, rear, right, and left are indicated in the drawings by arrows. The present embodiment describes a case where the present invention is applied to a parking assist system, as a driving assist system for a vehicle with self-driving capability. FIG. 1 is a block diagram of a system configuration of the present embodiment, centered around an automated-parking control unit 1. FIG. 2 is a tap view of a vehicle 100 mounted with the system in FIG. 1.

The automated-parking control unit 1 is an automated-parking ECU (Electronic Control Unit) to implement a driving assist system of the present invention. The automated-parking control unit 1 is configured to be centered around a microcomputer to implement functions of various controllers as follows, through processing executed by control programs of the controllers. That is, the automated-parking control unit 1 executes functions of a behavior controller 1b and an automated-parking controller 11 (a suspension hold controller). The automated-parking controller 11 executes functions of an available parking position detector 11a and a desired parking position detector 11b. In addition, the automated-parking control unit 1 executes functions of a parking activation instruction detector 12, brake hold instructor 13, and a brake hold continuation determiner 14. Further, the automated-parking control unit 1 executes functions of a brake hold cancel instructor 15, a first parking operation interrupter 16, a second parking operation interrupter 17, a resume instructor 18, and a brake fluid pressure controller 19. Details of processing executed by these components are described below.

The automated-parking control unit 1 has a camera group 21 and a sonar group 22 connected thereto. Note that the components connected to the automated-parking control unit 1 (connection is indicated by mapping lines) may be connected to the automated-parking control unit 1, either directly or via CAN (Controller Area Network).

The camera group 21 includes cameras mounted on the vehicle 100 in FIG. 2. That is, the vehicle 100 is provided with a front camera 21F arranged at a front of the vehicle 100 to image objects in front of the vehicle 100. Likewise, the vehicle 100 is provided with a rear camera 21R arranged at a rear of the vehicle 100 to image objects posterior to the vehicle 100. Additionally, the vehicle 100 is provided with a side camera 21RF arranged at a right front of the vehicle 100 to image objects on the right side of the vehicle 100. Likewise, the vehicle 100 is provided with a side camera 21LF arranged at a left front of the vehicle 100 to image objects on the left side of the vehicle 100. Note that the side cameras 21RF and 21LF may be desirably arranged at front ends of door mirrors or off from the door mirrors to avoid the door mirrors from being imaged excessively large. Of course, the side cameras may be arranged at other positions away from the door mirrors to some extent.

The sonar group 22 includes sonars mounted on the vehicle 100 in FIG. 2. That is, the vehicle 100 is provided with four front sonars 22F aligned at the front of the vehicle 100 substantially at equal intervals. The four front sonars 22F detect obstacles in front of the vehicle 100. In addition, the vehicle 100 is provided with four rear sonars 22R aligned at the rear of the vehicle 100 substantially at equal intervals. The four rear sonars 22R detect obstacles posterior to the vehicle 100. The front sonars 22F and rear sonars 22R detect obstacles in moving directions, forward and rearward, respectively.

The vehicle 100 is further provided with a side sonar 22RF at a right-front lateral side of the vehicle 100. The side sonar 22RF detects obstacles in a field between a right-front direction and a right lateral direction from the vehicle 100. Likewise, the vehicle 100 is provided with a side sonar 22LF at a left-front lateral side of the vehicle 100. The side sonar 22RF detects obstacles in a field between a left-front direction and a left lateral direction from the vehicle 100. Additionally, the vehicle 100 is provided with a side sonar 22RR at a right-rear lateral side of the vehicle 100. The side sonar 22RR detects obstacles in a field between a right-rear direction and a right lateral direction from the vehicle 100. Likewise, the vehicle 100 is provided with a side sonar 22LR at a left-rear lateral side of the vehicle 100. The side sonar 22LR detects obstacles in a field between a left-rear direction and a left lateral direction from the vehicle 100. The side sonars 22RF, 22LF, 22RR, 22LR detect obstacles which may possibly be hit by the vehicle 100. Dashed lines in FIG. 2 each indicate a spatial range where the corresponding sonar can detect obstacles.

Note that the number, and installation positions, of cameras and sonars as described above are not limited to those described, and the cameras and/or sonars may be increased or decreased in number, and/or installed at different positions. However, the number, and installation positions, of cameras and sonars are desirably selected as much as possible so as to detect conditions all around the vehicle 100. Alternatively, sensors other than the cameras and sonars may be used to detect conditions external to the vehicle 100.

Back to FIG. 1, the automated-parking control unit 1 has an inertia sensor 23, wheel speed sensors 24, a shift position sensor 25, and a gradient sensor 26 (road surface gradient detector) connected thereto. The inertial sensor 23 detects acceleration of the vehicle 100. The wheel speed sensors 24 detect wheel speeds of wheels of the vehicle 100. The shift position sensor 25 detects a shift position of a transmitter mounted on the vehicle 100. The gradient sensor 26 detects a road surface gradient as a gradient of a road surface on which the vehicle is located. The gradient sensor 26 has a gyroscope and uses an angular speed detected by the gyroscope to calculate an angle in a vertical direction between a pitch direction and a horizontal surface, so as to be detected as a road surface gradient. The sensors 21 to 25 of a sensor group are all configured to communicate with the automated-parking control unit 1 via a vehicle network.

In addition, the automated-parking control unit 1 has an information input/output device 31 connected thereto. The information input/output device 31 includes a touch panel 32 and a speaker 33. A main body of the information input/output device is arranged in the vicinity of a driver seat so that a driver can operate the touch panel 32 and the like. The information input/output device 31 displays various information on the touch panel 32, outputs various kinds of sound from the speaker 33, and receives various kinds of operation through the touch panel 32.

In other words, the information input/output device 31 can display automotive navigation information, produced based on such as a satellite positioning system, and outputs sound from the speaker 33. The information may include information received from a vehicle information and communication system (VICS).

The information input/output device 31 may also receive television broadcasting and/or sound broadcasting to display images on the touch panel 32 and output sound from the speaker 33. The information input/output device 31 may also include an optical disk device (not shown) to play a CD (Compact Disk), a DVD (Digital Video or Versatile Disk), a BD (Blu-ray Disc), or the like. The information input/output device 31 may also include an HDD (Hard Disk Drive), not shown, to play sound such as music stored therein. The information input/output device 31 may further inform various messages from the vehicle 100 or equipment mounted thereon, such as an ETC (Electronic Toll Collection system), and receive various kinds of operation on the touch panel 32 from the vehicle 100 and/or equipment mounted thereon.

The automated-parking control unit 1 has a braking system 41 connected thereto. The braking system 41 is a system to brake the vehicle 100. The braking system 41 includes a braking device 42 to brake the vehicle 100, and a braking control unit 43 to control the braking device 42. The braking control unit 43 includes a function as an automated brake hold control unit 44. The automated brake hold control unit 44 works as an automated brake hold controller. The braking device 42 generates fluid pressure (oil pressure) and supplies the fluid pressure to wheel cylinders of wheels, not shown, to produce frictional braking forces. Note that the braking system 41 may utilize regenerative brakes in combination in a case where the vehicle 100 is a hybrid vehicle or the like. The braking device 42 is a device applied with a brake-by-wire system, for example. Accordingly, the braking device 42 is capable of generating a braking force, regardless of operation on a brake pedal (not, shown), Alternatively, the braking device 42 may be a system mounted with an electric brake booster. Even in this case, the braking device 42 is capable of generating a braking force, regardless of operation on a brake pedal (not shown). The braking control unit 43 is a control device to control the braking device 42.

The automated brake hold control unit 44 is a feature included in the braking control unit 43, to control an automated brake hold function to hold a braking state even when a driver has stepped on a brake pedal (not shown) and then has stepped off the brake pedal. Note that the automated brake hold function cancels an automated brake hold state when a predetermined condition is satisfied, such as operation on an acceleration pedal (not shown). The automated brake hold state is activated or canceled through operation of a brake hold switch 45 arranged in the vicinity of a driver seat within the vehicle 100.

The automated-parking control unit 1 has a driving system 51 connected thereto. The driving system 51 is a system to cause the vehicle 100 to travel. The vehicle 100 is a hybrid vehicle in the present example and includes an engine 52 and a motor/generator 53 as driving sources. A hybrid control unit 54 controls the engine 52 and the motor/generator 53 to cause the vehicle 100 to travel. Note that the vehicle 100 is not limited to a hybrid vehicle. Only the engine 52 is used as a driving source for a gasoline vehicle. Only a motor is used as a driving source for an electric vehicle inclusive of a fuel cell vehicle.

A transmission system 61 is a system to shift gears of the vehicle 100. The transmission system 61 includes a transmission 62 to shift gears of the vehicle 100, a transmission control unit 63 to control the transmission 62, and a shift lever 64 connected with the transmission 62. The transmission 62 may be an automatic transmission or a manual transmission. The transmission system is capable of shifting gears by the transmission 62, without operation by a driver, through control by the transmission control unit 63. In this case, the transmission control unit 63 changes a position of the shift lever 64, depending on the shifting. The automated-parking control unit 1 has a driver presence determination unit 65 connected thereto. The driver presence determination unit 65 determines whether or not a driver is seated in a driver seat.

The automated-parking control unit 1 has an EPS (Electric Power-Steering) system 71 connected thereto, The EPS system 71 is a system to assist steering by a driver. The EPS system 71 includes a steering shaft 73 mounted with a steering wheel 72, a driving motor 74 to rotationally drive the steering shaft 73, and an EPS control unit 75 to control the driving motor 74. The EPS system 71 causes the steering shaft 73 to be rotated by the driving motor 74 as a driving source, to assist the driver turning the steering wheel 72 for steering.

The automated-parking control unit 1 includes an environment recognizer 1a to recognize environment of a vehicle, and a behavior controller 1b to execute behavior control inclusive of steering and acceleration/deceleration, based on recognized information, as shown in FIG. 1. The environment recognizer 1a recognizes conditions such as positions of surrounding vehicles, speed, and acceleration, based on information inputted from the camera group 21, the sonar group 22, and the like. The surrounding vehicles are vehicles traveling around the vehicle in question and heading in the same direction as the vehicle in question. The environment recognizer 1a may also recognize positions of other objects, such as a guard rail, a utility pole, a parked vehicle, and a pedestrian, in addition to the surrounding vehicles.

The behavior controller 1b suspends the vehicle 100 with behavior control, and holds the suspension until receiving behavior-related operation by the driver.

The automated-parking controller 11 (suspension hold controller) suspends the vehicle with behavior control by the behavior controller 1b, and holds the suspension until receiving behavior-related operation by the driver.

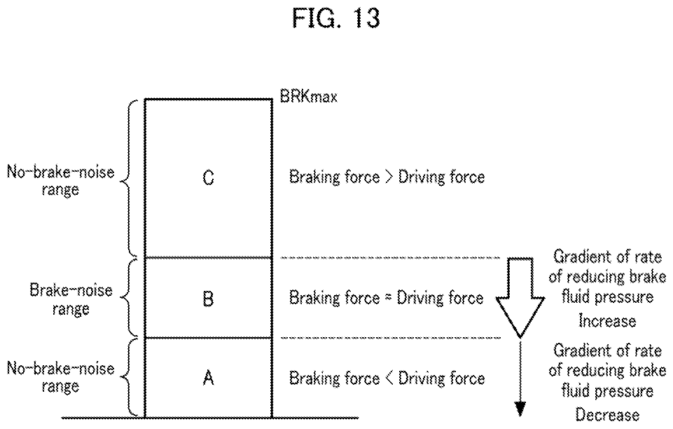

Based on a current position of the vehicle 100 and a desired parking position decided by the driver, the automated-parking controller 11 sets a reverse steering position 222 (see FIGS. 10 and 13) between the current position and the desired parking position, moves from the current position to the reverse steering position 222, and executes stationary steering at the reverse steering position 222.

The brake fluid pressure controller 19 increases or decreases a brake fluid pressure as a braking force for a wheel. The brake fluid pressure controller 19 varies a change rate of the brake fluid pressure and, when the vehicle 100 is made to start moving forward or backward, estimates a range having a brake noise and increases the change rate of the brake fluid pressure in a brake-noise range having a brake noise as compared with that in a no-brake-noise range. Specifically, the brake fluid pressure controller 19, when the vehicle 100 is made to start moving forward or backward, estimates a range having a brake noise, and decreases a gradient of a rate of reducing the brake fluid pressure in a no-brake-noise range having no brake noise (see Range A in FIG. 13), while increases the gradient of the rate of reducing the brake fluid pressure in a brake-noise range having a brake noise (see Range B in FIG. 13).

Estimating a range having a brake noise, as described above, is executed as follows, for example. That is, a brake noise is made (or frequency of occurrence is obtained) in advance through experiment or the like, with braking operation and a driving force as parameters, to obtain one or more brake-noise ranges and no-brake-noise ranges, and then the one or more brake-noise ranges and no-brake-noise ranges are stored in a storage unit (not shown). When executing the brake fluid pressure control, the brake fluid pressure controller 19 retrieves the one or more brake-noise ranges and no-brake-noise ranges from the storage unit, based on braking operation and a driving force, to estimate a range having a brake noise. Alternatively, as a simplified method, such an assumption may be made in a case of braking with self-driving, when causing a vehicle to start moving forward or backward, that the brake fluid pressure keeps falling in the no-brake-noise range for a first predetermined period and then in the brake-noise range for a second predetermined period. The brake fluid pressure controller 19 counts the first and second predetermined periods to estimate the respective ranges.

The brake fluid pressure controller 19 varies a gradient of a rate of reducing the brake fluid pressure, based on a gradient of a course of movement. When the gradient is of a downhill, for example, the brake fluid pressure controller 19 decreases the gradient of the rate of reducing the brake fluid pressure in the no-brake-noise range, as compared with a case where the gradient is not graded, while increases the gradient of the rate of reducing the brake fluid pressure in the brake-noise range, as compared with a case where the gradient is not graded. Likewise, when the gradient is of an uphill, the brake fluid pressure controller 19 increases the gradient of the rate of reducing the brake fluid pressure in the non-brake-noise range, as compared with a case where the gradient is not graded, while decreases the gradient of the rate of reducing the brake fluid pressure in the brake-noise range, as compared with a case where the gradient is not graded.

The brake fluid pressure controller 19 executes brake fluid pressure control to decrease a brake fluid pressure from the predetermined pressure to the desired brake fluid pressure, where the desired brake fluid pressure is set to one with a brand-new brake pad as standards.

The automated-parking controller 11 shifts a position in a shift range of the transmission mounted on the vehicle 100 from a D-range to an R-range at the reverse steering position 222, based on shift position data from the shift position sensor 25.

When braking operation is canceled by the driver, the automated-parking controller 11 starts moving to the desired parking position.

The vehicle 100 is provided with the gradient sensor 26 to detect a gradient of a road surface on which the vehicle 100 is located, and the brake fluid pressure controller 19 varies a brake fluid pressure, based on a gradient of a course of movement detected by the gradient sensor 26. Here, when the gradient is of a downhill, the brake fluid pressure controller 19 increases the brake fluid pressure.

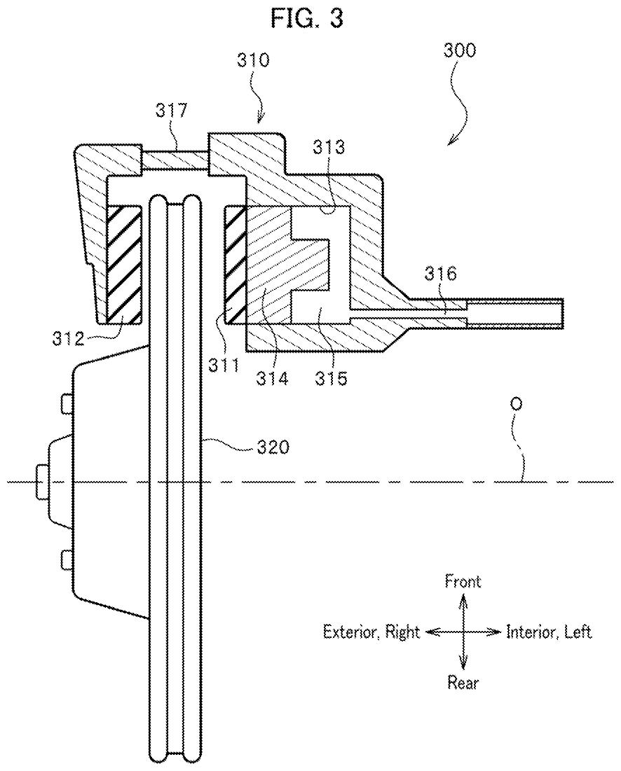

The vehicle 100 (see FIG. 1) is provided with a disk brake 300 to press brake pads 311, 312 (see FIG. 3) against a disk 320 by way of oil pressure to brake the vehicle 100. The brake fluid pressure controller 19 executes brake fluid pressure control to increase a brake fluid pressure from a constant pressure (predetermined pressure) to the desired brake fluid pressure. The desired brakefluid pressure may be set to one with a brand-new brake pad as standards.

FIG. 3 shows the disk brake 300 for the vehicle 100. As shown in FIG. 3, the disk brake 300 stops the disk 320 in a disk shape from being rotated together with a wheel, not shown, to brake the vehicle. Hereinbelow, an orientation of a central axis of the disk 320 is referred to as an orientation of a rotation axis O. The disk brake 300 includes: a caliper 310 slidable in a parallel direction parallel to the rotation axis of the wheel with reference to a vehicle body, between an initial position and an operational position; a first brake pad 311 facing one surface of the disk 320 to be rotated together with the wheel; a second brake pad 312 facing the other surface of the disk 320 and supported by the caliper 310 via a bridge 317 so as to be relatively movable in the parallel direction; and an oil pressure cylinder 313 supported by the caliper 310 and supporting the first brake pad 311, and moving the caliper 310, which has been positioned at the initial position by a reaction force received from the disk 320 via the first brake pad 311 when a driving force has been generated to move the first brake pad 311 so as to contact the disk 320, to the operational position to cause the second brake pad 312 to contact the disk 320.

The first brake pad 311 is an inner friction pad disposed on an inner side, inner in a vehicle width direction than the disk 320. The second brake pad 312 is an outer friction pad disposed on an outer side, outer in the vehicle width direction than the disk 320.

The oil pressure cylinder 313 is positioned on an interior side of the vehicle with respect to the disk 320. The oil pressure cylinder 313 specifically includes a cylinder 313 fixed to the caliper 310 and having an axis line in parallel to the rotation axis O, and a piston 314 partially positioned within the cylinder 313 and slidable with respect to the cylinder 313. The piston 314 supports the first brake pad 311 at a front end thereof. The cylinder 313 is formed therein with a communication hole 316 to communicate a fluid pressure chamber 315 with outside, and brake fluid is introduced into the fluid pressure chamber 315 through the communication hole 316. The brake fluid introduced into the fluid pressure chamber 315 causes the piston 314 to proceed toward the disk 320.

When a driver of the vehicle teps on the brake pedal, oil pressure increases in the oil pressure cylinder 313 to move the piston 314 of the oil pressure cylinder 313 toward the disk 320 so that the first brake pad 311 is pressed against a side surface on the interior side of the disk 320.

The disk 320 is unable to be moved in the rotation axis direction, relative to the vehicle body. Accordingly, when the first brake pad 311 is pressed against the disk 320, the first brake pad 311 receives a reaction force from the disk 320, to cause the caliper 310 at the initial position to be relatively slid, with respect to the vehicle body, toward the interior side so as to be moved to the operational position. Then, the second brake pad 312 supported by the caliper 310 is pressed against a side surface on an exterior side of the disk 320. As a result, a braking force (friction resistance force) is exerted to the disk 320 from the second brake pad 312 and the first brake pad 311, to decrease a rotation speed of the disk 320.

On the contrary, when the driver steps off the brake pedal, the oil pressure in the oil pressure cylinder 313 is reduced to cause the piston 314 to return to the initial position. That is, the oil pressure cylinder 313 comes close to the disk 320, and the caliper 310 at the operational position is moved to the initial position. Accordingly, the second brake pad 312 is separated from the disk 320, and the first brake pad 311 is separated from the disk 320 toward the interior side, with the piston 314 moving to the initial position.

### <Brake Noise>

When the vehicle 100 is braked, the brake pads 311, 312 are pressed by oil pressure against the disk 320. At this time, the caliper 310 may be vibrated, depending on such as conditions of the brake pads 311, 312 and a condition of the disk 320, to make an abnormal noise, that is, a brake noise. When braking is gradually canceled, for example, an abnormal noise (brake noise) may be made, depending on a balance between a frictional force generated by the brake pads 311, 312 and a driving force. As shown in FIG. 3, such a noise can be made when the brake pads 311, 312 are separated from the disk 320 after being pressed against the disk 320.

In a case of a manual-mode driving where a driver can adjust a canceling speed of braking with a stepping force on the brake pedal, an experienced driver can reduce an abnormal noise by adjusting a stepping force. However, in a case where braking is automatically canceled, an abnormal noise is desirably prevented by control of the vehicle itself.

Especially, when a stationary steering (steering with a vehicle in a suspended condition) is operated with automated steering by the driving assist system after the vehicle has been suspended (with the brake on hold) at a predetermined position, if a brake noise is made, the driver is more sensitive to the brake noise for a reason of automated steering. All the more in a case where the vehicle is an EV (Electric Vehicle), which is superior in quietness, or the like, a brake noise at stationary steering notably brings uncomfortable feeling or discomfort to a driver.

In the present embodiment, when the vehicle is made to start moving forward or backward at the time of automated-parking control by the automated-parking controller 11, the brake fluid pressure controller 19 decreases the gradient of the rate of reducing the brake fluid pressure in the non-brake-noise range having no brake noise, while increases the gradient of the rate of reducing the brake fluid pressure in the brake-noise range having a brake noise, so that the brake fluid pressure is quickly reduced in the brake-noise range to shorten a time of staying in the brake-noise range as much as possible for mitigating influence from a brake noise.

### <Automated-Parking Operation>

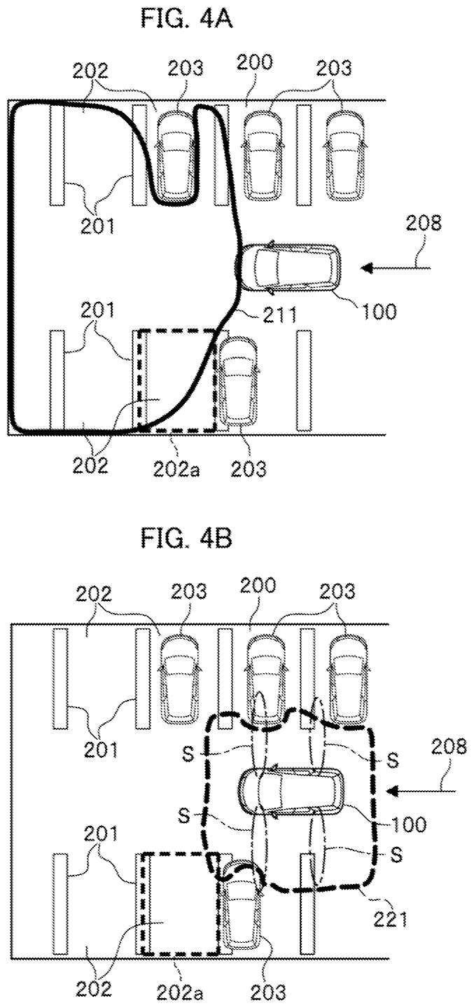

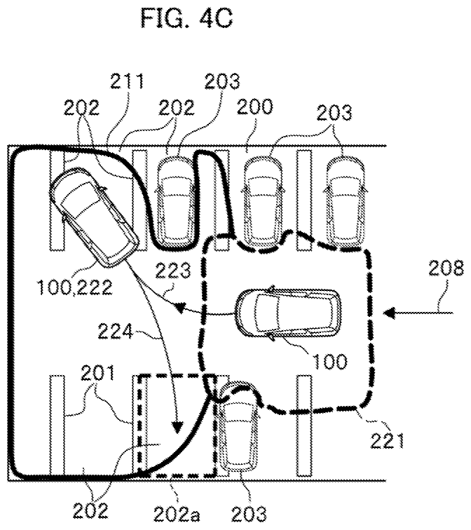

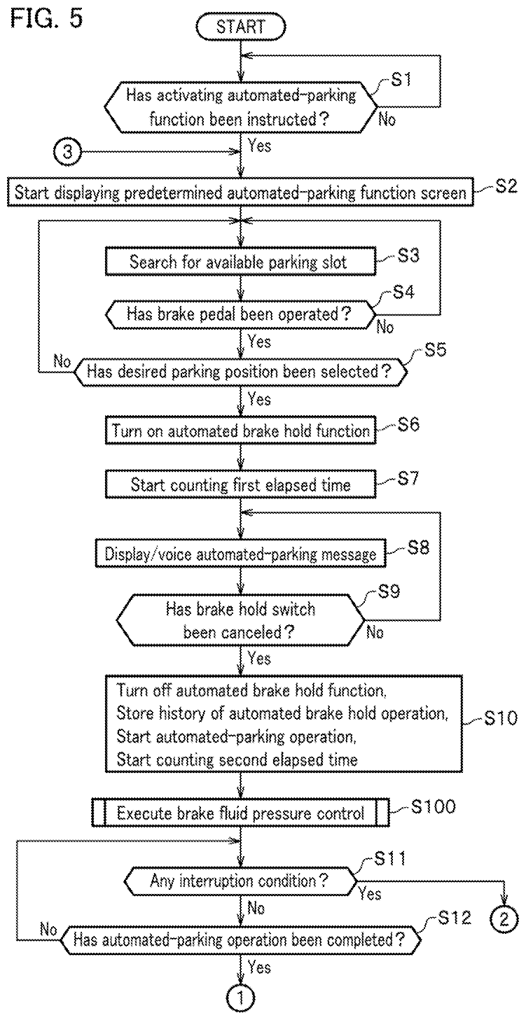

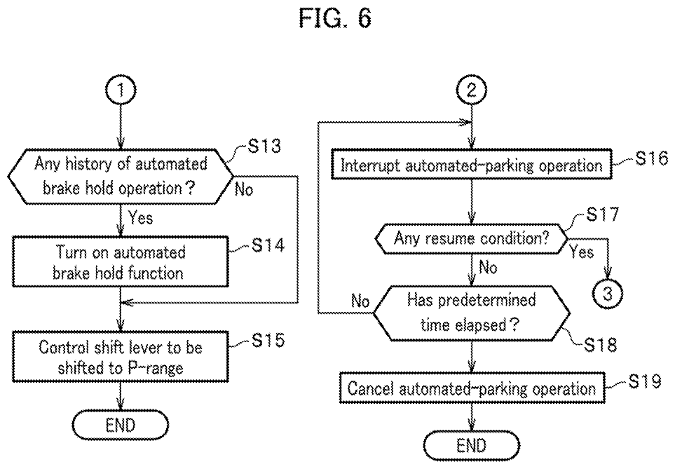

Hereinbelow, a description is given of operation of systems centered around the automated-parking control unit 1. “Automated-parking operation” hereinbelow refers to a series of operation in a flowchart in FIGS. 5 and 6, to be described below, in which the automated-parking control unit 1 controls the systems, for automated driving, to drive the vehicle 100 to execute automated-parking. “Automated-parking function” refers to all the processing of automated-parking in the flowchart in FIGS. 5 and 6, inclusive of the “automated-parking operation” to be executed mainly by the automated-parking control unit 1. The automated-parking control unit 1 controls automated-parking. For this purpose, the camera group 21 and the sonar group 22 are used to detect a space for parking in a parking area or the like. FIGS. 4A to 4C each show the vehicle 100, in a top view, in search of a space for parking.

At first, FIG. 4A shows the vehicle 100, in a top view, in search of a space for parking in a parking area 200, mainly using the front camera 21F of the camera group 21. After the vehicle 100 entering the parking area 200, parking slots 202 segmented by white lines 201 are in a row respectively on the right and left sides as viewed from the vehicle 100, where some parking slots 202 have other vehicles 203 already parking and other parking slots 202 are available for parking. The vehicle 100 is driven by the driver to slowly move forward in a direction indicated by an arrow 208.

Images taken by the front camera 21F (see FIG. 2) allow for recognizing an area 211 as an available space for the vehicle 100 to park. The images taken by the front camera 21F are processed with predetermined image processing to allow for recognizing luminance differences. This allows the vehicle 100 to recognize the area 211 available for parking. Recognition by camera is good at recognizing the white lines 201. Recognition by camera includes space recognition capability. Recognition by camera is not good at recognizing snow, white walls, and other nearby vehicles. Accordingly, only the images taken by the front camera 21F are not enough to control braking for obstacles, which is required for automated-parking.

Then, the sonar group 22 is used in combination. FIG. 4B is a top view of the parking area, to show the vehicle 100 in search of a space for parking in the parking area 200, using all sonars of the sonar group 22. A sonar can detect obstacles by transmitting and receiving sonic waves, and is good at detecting nearby obstacles, which a camera is not good at. Sonars are therefore required to accurately control braking for obstacles. Additionally, a sonar has a higher space recognition capability than a camera, so that the sonar group 22 is helpful to conduct various ways of parking. FIG. 4B shows an area 221 available for parking, recognized by the sonar group 22.

FIG. 4C is a top view of the parking area, with the area 211 and the area 221 collectively shown. The front camera 21F and the sonar group 22 are used in combination to recognize a wide space as being available for parking. This also eases controlling braking for obstacles. In the example in FIG. 4C, a parking slot 202a is determined to be a space for automated-parking. Additionally, a space on the far right, as viewed from the vehicle 100, is empty and thus determined as a position to start reverse steering of the vehicle 100. This allows the automated-parking control to move the vehicle 100 forward and turn the steering wheel to the right, suspend the vehicle 100 at the reverse steering position 222 (arrow 223), and reversely turn the steering wheel and move the vehicle 100 backward into the parking slot 202a (arrow 224).

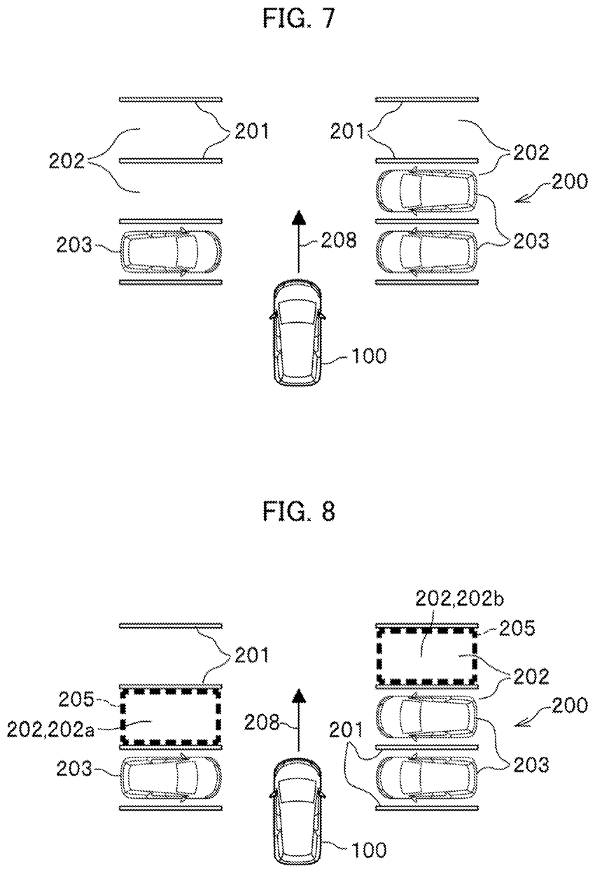

Hereinabove is a summary of automated-parking to use the front camera 21F and the sonar group 22 in combination, and an automated-parking process is described below in detail. FIGS. 5 and 6 each show a flowchart of a process executed by the automated-parking control unit 1. FIGS. 7 to 10 are each a top view of the parking area, to illustrate processing executed by the automated-parking control unit 1. Note that the flowchart shows a summary of a series of processing to be described below, but does not show detailed processing executed by the automated-parking control unit 1. Processing not shown in the flowchart is described below as required.

First, the driver personally drives the vehicle 100 to enter the parking area 200, as indicated by the arrow 208. At this time, the driver operates the touch panel 32 or the like to instruct activating an automated-parking function (Yes in S1). The instruction of activating the automated-parking function is received by the parking activation instruction detector 12. Then, the parking activation instruction detector 12 displays a predetermined automated-parking function screen on the touch panel 32 (S2). Note that various kinds of automated-parking function screens are displayed, as required, in the series of processing. The available parking position detector 11a of the automated-parking controller 11 uses the front camera 21F and the sonar group 22 in combination, in a manner as described above with reference to FIGS. 4A to 4C, The available parking position detector 11a then searches for an available parking slot for parking, through the combined usage (S3).

Following processing is executed in S3 based on the searching result. First, the available parking position detector 11a detects available parking positions (the parking, slots 202) for the vehicle 100. Parking slots 202a, 202b are candidates for desired parking positions in the example in FIG. 8. Additionally, the available parking position detector 11a calculates a route to avoid obstacles when the vehicle 100 parks in the parking slot 202a or 202b, based on the detection results by the front camera 21F and the sonar group 22.

Next, the desired parking position detector 1b estimates a current position of the vehicle 100, based on the detection results by the inertia sensor 23 and the wheel speed sensors 24. The desired parking position detector 11b then calculates a desired moving route of the vehicle 100 for parking in the parking slot 202a or 202b, based on the current position. The desired parking position detector 11b then displays positional relationships between the vehicle 100 (vehicle in question) and the parking slots 202a, 202b on the touch panel 32. The parking slots 202a, 202b are each indicated by a marking in the image, such as enclosing the slot with a frame 205, for easy understanding of the driver.

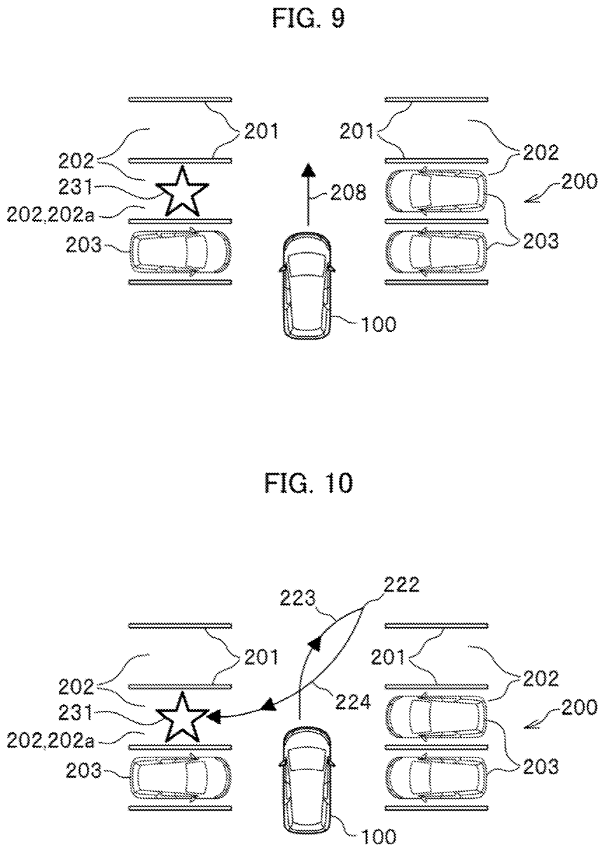

When the result has been “Yes” in S1, processing in S3 is executed (also when the result is No in S4), while the driver personally drives the vehicle 100 to move within the parking area 200. Then, when the driver steps on the brake pedal, not shown, (Yes in S4) to stop the vehicle 100, the desired parking position detector 11b executes the next processing. That is, with the driver operating the touch, panel 32 to select a desired parking position (Yes in S5), the desired parking position detector 11b determines the selected position as the desired parking position. The selection may be made such as by touching an area indicated by the frame 205. When the selection has not been made (No in 55), the processing in 53 continued. Note that the sequence of processing in 54 and 55 may be reversed. When the desired parking position is determined as described above (Yes in S5), the desired parking position detector 11b displays a marking 231, as in FIG. 9, within the image of the desired parking position (parking slot 202a in this case) on the touch panel 32.

Next, the brake hold instructor 13 instructs the automated brake hold control unit 44 to turn on an automated brake hold function (S6). The automated brake hold control unit 44 works as the automated brake hold controller. This allows for automatically retaining a state of the vehicle 100 being braked, even when the driver steps off the brake pedal (not shown).

The first parking operation interrupter 16 subsequently starts counting an elapsed time (first elapsed time) with a timer (S7). The automated-parking controller 11 displays an automated-parking message on the touch panel 32, and informs the driver of the automated-parking message by way of the speaker 33 (S8). In this case, the automated-parking message may only be displayed on the touch panel 32. Here, the message for the driver is given to the driver using an HMI (Human Machine Interface) internal notification message such as “please step off the brake pedal.” The message can be one to the effect “Automated brake hold has been turned on. In order to make automated-parking start, please push the brake hold switch, hands off the steering wheel, and step off the brake pedal,” for example.

Once the driver has executed all the actions instructed in the message, the brake hold switch 45 is pushed down to cancel the brake hold switch 45 (Yes in S9). In this case, pushing down the brake hold switch 45 can be interpreted as operation by a cancel instruction controller. When the brake hold switch 45 is not canceled (No in S9), the message described above is continuously displayed on the touch panel 32. Note that when predetermined operation is made in course of a series of processing (S2 to S8) as described above, the series of automated-parking processing is discontinued. The operation includes the driver operating the touch panel 32, on a screen of the automated-parking function displayed thereon, to discontinue operation of the automated-parking function and intentionally operating the shift lever 64.

When the brake hold switch 45 is canceled (Yes in S9), processing in S10 is executed. That is, the brake hold cancel instructor 15 instructs the automated brake hold control unit 44 to turn off the automated brake hold function (S10). This leads to canceling the vehicle 100 being braked. In addition, the brake hold continuation determiner 14 stores such a history that the automated brake hold function has been operated in 56 into a non-volatile memory or the like (S10). Further, the automated-parking controller 11 starts automated-parking operation (operation details are described below) (S10). Furthermore, the second parking operation interrupter 17 starts counting elapsed time (second elapsed time) with the timer (S10). Note that when there is no operation on the brake pedal (not shown), the automated-parking controller 11 executes following control. That is, the automated-parking controller 11 cancels the brake hold switch 45 (S9), but does not proceed to automated-parking operation (S10). However, even in this case, the automated brake hold function itself is kept ON (S6).

The automated-parking operation started by the automated-parking controller 11 is as follows. That is, the automated-parking controller 11 control the vehicle 100 so as to move on the desired moving route as determined in 33, as shown in FIG. 10. The automated-parking controller 11 controls the braking system 41, the driving system 51, the transmission system 61, and the EPS system 71. This causes the vehicle 100 to move backward to the parking slot 202a as the desired parking position.

That is, the automated-parking controller 11 controls these systems so that the vehicle 100 moves forward with the D-range as indicated by the arrow 223, and suspends at the reverse steering position 222. Next, the automated-parking controller 11 causes the vehicle 100 to move backward with the R-range into the parking slot 202a as the desired parking position, and then to stop.

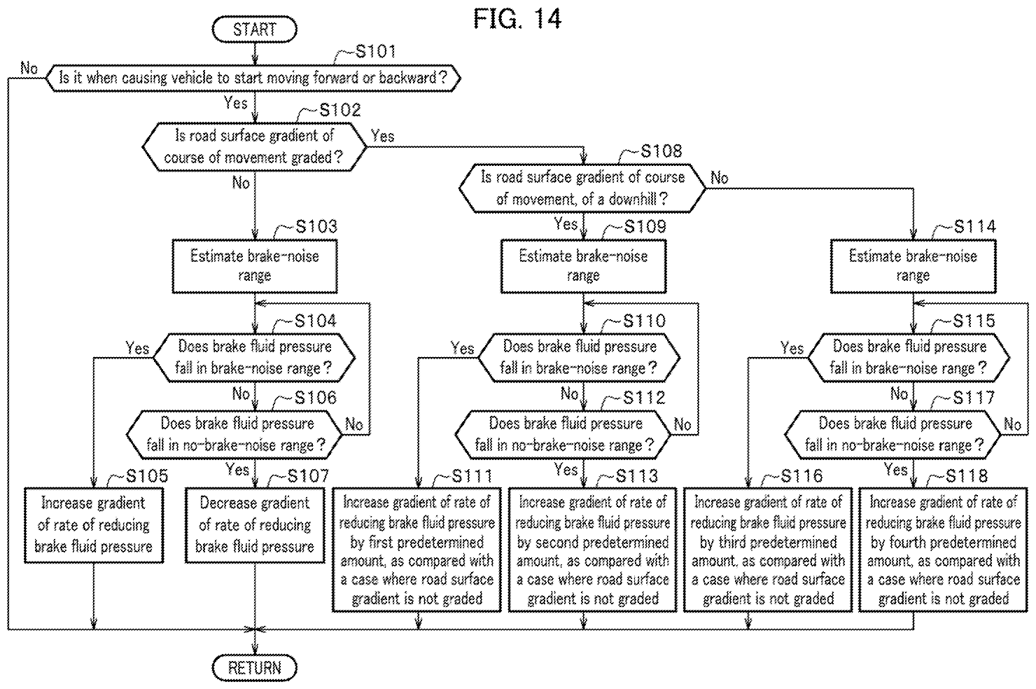

In step S100, the brake fluid pressure controller 19 (see FIG. 1) varies the gradient of the rate of reducing the brake fluid pressure, when the vehicle 100 is made to start moving forward or backward (see FIG. 14 to be described below).

After the automated-parking operation has been started (S10), a determination is made whether or not there is any interruption condition to interrupt the automated-parking function while the automated-parking is in operation (S11). Namely, the interruption condition in S11 includes the steering wheel 72 being operated and the shift lever 64 being shifted to an N-range.

In addition, the first parking operation interrupter 16 determines in S11 whether or not the first elapsed time (the counting has been started in S7) is equal to or greater than a predetermined time. The first elapsed time is a time since the desired parking position has been decided (S5, S7) until operation of canceling the automated brake hold by way of the brake hold switch 45 is received (Yes in S9). The first elapsed time being equal to or greater than a predetermined time is also an interruption condition. Further, the second parking operation interrupter 17 determines in S11 whether or not the second elapsed time (the counting has been started in S10) is equal to or greater than a predetermined time. The second elapsed time is a time since the brake hold switch 45 has been operated (Yes in S9) until canceling operation on the brake pedal (not shown) is detected (Yes in S9). The second elapsed time being equal to or greater than a predetermined time is also an interruption condition.

The determination, by the driver presence determination unit 65, of a driver not being seated in a driver seat is also an interruption condition. The driver presence determination unit 65 is implemented with a seating sensor to detect whether or not the driver is seated in the driver seat, an in-vehicle camera to image interior of the vehicle (image processing allows for determining whether or not the driver is seated in the driver seat), a door opening sensor to detect whether or not a door for the driver seat is opened, or the like. Additionally, an interruption condition can be selected from various conditions to be considered to interrupt an automated-parking function. When the automated-parking operation has been completed without any interruption condition (Yes in S12), the touch panel 32, the speaker 33, and/or the like is/are used to inform that the automated-parking operation has been completed. Then, the processing proceeds to S13. When the automated-parking operation has been interrupted with some interruption condition (No in S12), the processing proceeds to S16.

In S13, the brake hold continuation determiner 14 determines whether a history of automated brake hold operation has been stored in S10. When such a history is stored (Yes in S13), the braking system 41 is controlled in S14 to turn on the automated brake hold function again, and the processing proceeds to S15. The vehicle 100 is thus braked to stop, although the driver does not step on the brake pedal (not shown). When such a history is not stored (No in S13), the processing proceeds to S15. In this case, the automated brake hold function is kept off. Following is the case where a history of automated brake hold operation has not been stored in S10. That is, even when the automated brake hold function is turned on in S6, the driver deliberately operates the brake hold switch 45 to turn off the function. In S15, the automated-parking controller 11 controls the shift lever 64 to shift to the P-range, and then the automated-parking ends.

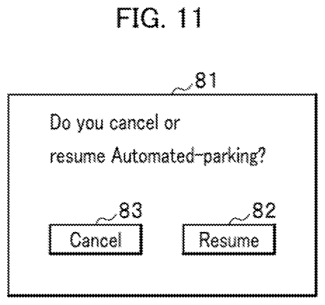

In S16, some interruption condition exists (Yes in S11) and therefore the automated-parking function is interrupted. Then, a determination is made whether or not there is any condition for resuming the automated-parking function (S17). Such a resume condition includes a predetermined condition being fulfilled. The predetermined condition includes predetermined operation having been executed on a selection screen 81, shown in FIG. 11 as one of screens displayed on the touch panel 32 for the automated-parking function. The selection screen 81 shows a resume switch 82 and a cancel switch 83. The driver operating the resume switch 82 becomes a resume condition. When the cancel switch 83 is operated, canceling the automated-parking function is selected.

When there is a resume condition (Yes in S17), the processing returns to S2 and the automated-parking function is resumed. When there is no resume condition and a predetermined time has elapsed (No in S17, Yes in S18), canceling the automated-parking function is settled (S19), and a series of processing ends. When there is no resume condition and the predetermined time has not elapsed (No in S17, No in S18), the processing returns to S16. Note that when the cancel switch 83 is operated, the automated-parking function may be canceled without waiting for the predetermined time to elapse (Yes in S18).

Note that when there is some interruption condition (Yes in S11), fulfilling the resume condition (Yes in S17) allows for resuming the automated-parking function from S2. In contrast, when the cancel condition is fulfilled during a series of operation of automated-parking function, the processing itself in FIGS. 5 and 6 is canceled to have no resuming. When the processing needs to be resumed, the processing from S1 is newly executed. The cancel condition includes the shift lever 64 being shifted to the P-range, electric parking brake being operated, and the touch panel 32 or the like being operated to instruct activating the automated-parking function, during a series of operation of the automated-parking function. In addition, a series of operation of the automated-parking function is suspended when a suspension condition is fulfilled during a series of operation of the automated-parking function, but once the suspension condition is canceled in this case, the series of operation of the automated-parking function is resumed from the point where the operation has been suspended. The suspension condition includes the brake pedal (not shown) being operated.

Further, there may be a case where the vehicle 100 is found to hinder another vehicle from moving ahead. The driver of the vehicle 100 then shifts the position of the shift level 64 from the D-range to the R-range. This cancels the automated-parking function and the selection screen 81 in FIG. 11 is displayed on the touch panel 32. Selecting the cancel switch 83 on this screen is followed by the driver personally driving the vehicle 100 to move backward for letting said another vehicle to go away. Then, the driver operates the touch panel 32 or the like again to instruct activating the automated-parking function for starting over automated-parking. When the resume switch 82 is operated, the automated-parking function resumes from S2.

The automated-parking control unit 1 described above executes following control after the automated-parking function has been activated (after Yes in S1) until parking operation to the desired parking position is started. That is, when the brake pedal (not shown) is operated (Yes in S4), the automated-parking control unit 1 turns on the automated brake hold function (S6). Accordingly, the braking force works even after the driver has stepped off the brake pedal (not shown), to prevent the vehicle 100 from unexpectedly moving.

The automated-parking control unit 1 requires following conditions in order to turn on the automated brake hold function (S6). That is, the conditions are that available parking slots have been detected (S3) and the driver has determined the desired parking position (Yes in S5). In other words, the automated-parking control unit 1 allows the driver to move the vehicle 100 before the driver determines a desired parking position. Also, the automated-parking control unit 1 allows for preventing the vehicle 100 from unnecessarily moving, after the driver has determined the desired parking position (Yes in S5).

In addition, the automated-parking control unit 1 executes following control when the automated brake hold function has been turned on (S6) and the automated-parking operation has been completed (Yes in S12). That is, a history of activating the automated brake hold is recorded (S10, Yes in S13). The automated-parking control unit 1 thus turns on the automated brake hold function (S14) after the automated-parking operation has been completed (Yes in S12). That is, when having been started with automated brake hold, the automated-parking ends with automated brake hold. This prevents the vehicle 100 from unexpectedly moving after the automated-parking operation has been completed (Yes in S12).

In contrast, even when the automated brake hold function has been turned on (S6), the driver may operate the brake hold switch 45 to turn off the automated brake hold function. In this case, the automated brake hold function is kept off (No in S13) after the automated-parking operation has been completed (Yes in S12), as intended by the driver.

Further, when the brake hold switch 45 is canceled (Yes in S9) while the driver is operating the brake pedal (not shown) (S4), control is executed as follows. That is, the automated-parking control unit 1 turns off the automated brake hold function in this case to cancel braking (S10), and starts automated-parking operation (S10). Accordingly, from a state of the driver operating the brake pedal (S4), braking is canceled and then the automated-parking operation is started (S10), to give a secure feeling to the driver.

Still further, the automated-parking control unit 1 makes operation of the shift lever 64, the steering wheel 72, or the brake pedal (not shown) as an interruption condition (S11). When the interruption condition is fulfilled, the automated-parking control unit 1 interrupts the automated-parking operation (S16). This allows for giving higher priority to the driver's intention to interrupt the automated-parking operation than to continuing the operation.

Still further, the first elapsed time or second elapsed time being equal to or greater than a predetermined time is also an interruption condition (S11). The first elapsed time is a time since the desired parking position has been decided (Yes in S5, S7) until the brake hold switch 45 is operated (Yes in S9). The second elapsed time is a time since the brake hold switch 45 has been operated (Yes in S9) until operation on the brake pedal (not shown) is canceled (S10). When the first elapsed time or second elapsed time is equal to or greater than the predetermined time, it is likely to happen that other vehicles 203 move in and/or out of the parking slots 202. In other words, this allows for preventing automated-parking operation from being executed in a situation possibly different from that when the available parking slots have been searched for (S3).

Still further, when automated-parking is interrupted (S16), the resume conditions are defined (S17). The resume conditions include the brake hold switch 45 being operated and a predetermined condition being fulfilled. The predetermined condition includes the resume switch 82 being operated in the selection screen 81, as one of screens displayed on the touch panel 32 for the automated-parking function. The automated-parking control unit 1 is thus capable of resuming the automated-parking function not only with operation of the brake hold switch 45 but also with operation of the resume switch 82 or the like.

<Brake Fluid Pressure Control Operation when Causing Vehicle to Start Moving Forward or Backward>

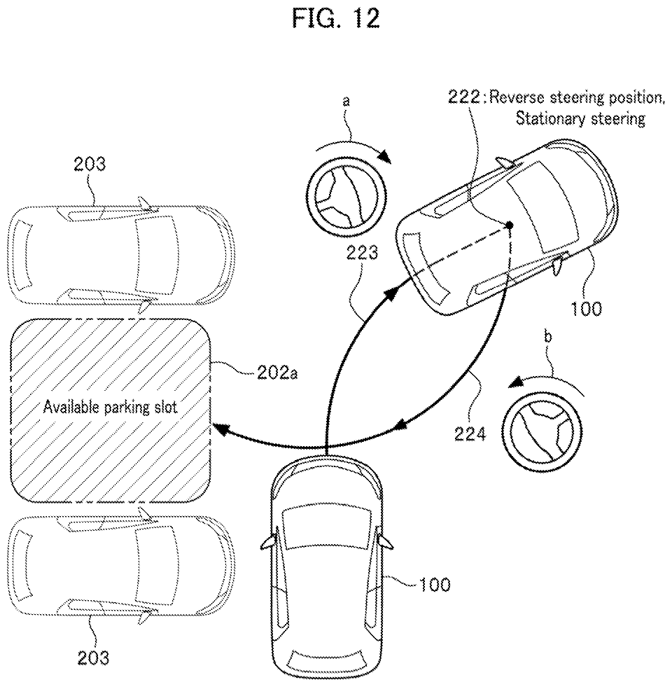

Next, a description is given of brake fluid pressure control by the brake fluid pressure controller 19, with reference to FIGS. 12 to 14. FIG. 12 is a top view of the parking area, to illustrate the brake fluid pressure control for braking, when the vehicle is made to start moving forward or backward, by the brake fluid pressure controller 19. Elements corresponding to those in FIG. 10 are denoted by the same reference numerals.

As shown in FIG. 12, the automated-parking controller 11 (see FIG. 1) of the automated-parking control unit 1 controls the above-described system to cause the vehicle 100 to turn right with automated steering (see arrow “a” in FIG. 12) so as to move forward with the D-range, as indicated by the arrow 223 in FIG. 12, and then suspend at the reverse steering position 222. The controller then causes the vehicle 100 to execute stationary steering (steering while the vehicle being in suspension) after the suspension at the reverse steering position 222 (while the brake hold being in operation), as shown in FIG. 12. Next, the automated-parking controller 11 causes the vehicle 100 to turn left with automated steering (see arrow “b” in FIG. 12) so as to move backward with the R-range, as indicated by the arrow 224 in FIG. 12, into the available parking slot 202a as the desired parking position, and then to stop.

### <Non-Brake-Noise Range: Range C>

FIG. 13 is a chart showing a relationship between a brake-noise range/a no-brake-noise range and a gradient of a rate of reducing the brake fluid pressure. As shown in FIG. 13, a braking force is larger than a driving force, when the vehicle is made to start moving forward or backward (the brake fluid pressure is within a predetermined range C under the maximum value BRKmax). The brake fluid pressure is increased when the vehicle is made to start moving forward or backward, and accordingly the brake pads 311, 312 (see FIG. 3) of the disk brake 300 is pressed hard against the disk 320. At this time, no brake noise is ever made because the brake pads 311, 312 have no vibration or the like. Note that the vehicle moving forward in FIG. 13 corresponds to causing the vehicle to start moving forward with the D-range, as indicated by the arrow 223, in FIG. 12, while the vehicle moving backward in FIG. 13 corresponds to causing the vehicle to start moving backward with the R-range, as indicated by the arrow 224, in FIG. 12. The case described above is merely an example, and the embodiment is applicable to any cases, as far as involving braking when the vehicle is made to start moving forward or backward.

### <Brake-Noise Range: Range B>

As shown in FIG. 13, the magnitude of pressing the brake pads 311, 312 with oil pressure against the disk 320 (see FIG. 3) is decreased with the decreasing braking force (brake fluid pressure), to cause the vehicle 100 to start moving forward or backward while being braked. At this time, the caliper 310 may have vibration depending on the conditions of the brake pads 311, 312 and disk 320, to make a brake noise. That is, a brake noise is made when the brake pads 311, 312 are separated from the disk 320 after having been pressed against the disk 320. Range B in FIG. 13 is a range where the braking force and the driving force are balanced with each other to have a brake noise (i.e., a brake-noise range).

When the brake fluid pressure is within this brake-noise range (range B), the gradient of the rate of reducing the brake fluid pressure is increased to quickly reduce the brake fluid pressure to shorten duration of time within the brake-noise range as much as possible for mitigating the influence from the brake noise. An enlarged outlined arrow in FIG. 13 indicates having the gradient of the rate of reducing the brake fluid pressure increased.

### <Non-Brake-Noise Range: Range A>

As shown in FIG. 13, the driving force becomes greater than the braking force with the further decreasing braking force (brake fluid pressure), to cause the braking fluid pressure to come out of the brake noise range (range B) and go into a no-brake-noise range (range A).

The gradient of the rate of reducing the brake fluid pressure is decreased in this no-brake-noise range (range A) to retain the braking force for preventing an abrupt acceleration. Note that in a case where the vehicle 100 travels on a downhill, the gradient of the rate of reducing the brake fluid pressure is more decreased to prevent abrupt acceleration more reliably. A thinned an arrow following the outlined arrow in FIG. 13 indicates having the gradient of the rate of reducing the brake fluid pressure decreased.

As described above, when the automated-parking control is executed by the automated-parking controller 11 with the present embodiment, the gradient of the rate of reducing the brake fluid pressure is increased in the brake-noise range (range B) to shorten duration of time within the brake-noise range as much as possible for mitigating the influence from the brake noise, while the gradient of the rate of reducing the brake fluid pressure is decreased in the no-brake-noise range (range A) to retain the braking force for preventing an abrupt acceleration. That is, in a case where the brake fluid pressure is transitioned from the no-brake-noise range (range C) when the vehicle is made to start moving forward or backward, as shown in FIG. 13, via the brake-noise range (range B) to the no-brake-noise range (range A), the gradient of the rate of reducing the brake fluid pressure is increased in the brake-noise range (range B) to promptly pass over the range in question.

FIG. 14 is a flowchart of the brake fluid pressure control for braking, when the vehicle is made to start moving forward or backward, by the brake fluid pressure controller 19. FIG. 14 shows a subroutine of step 100 in FIGS. 5 and 6. After a subroutine call in step 100 in FIG. 5, the automated-parking control unit 1 determines in S101 whether or not it is when the vehicle 100 is made to start moving forward or backward. When it is not when the vehicle 100 is made to start moving forward or backward (No in S101), the processing returns to step S100 in FIG. 5. When it is when the vehicle 100 is made to start moving forward or backward (Yes in S101), the automated-parking control unit 1 determines in S102 whether a road surface gradient of a course of movement is graded or not, based on output of the gradient sensor 26. When the road surface gradient of the course of movement is not graded (No in S102), the brake fluid pressure controller 19 estimates a brake-noise range (see range B in. FIG. 13) (S103). The estimation method has been described above.

The estimation result is used to determine whether or not the brake fluid pressure falls in the brake-noise range (S104). When the brake fluid pressure falls in the brake-noise range (Yes in S104), the gradient of the rate of reducing the brake fluid pressure is increased (S105). This allows for shortening duration of time within the brake-noise range as much as possible to mitigate the influence from the brake noise.

When the brake fluid pressure does not fall in the brake-noise range (No in S104), a determination is made whether or not the brake fluid pressure falls in the non-brake-noise range (see range A in FIG. 13) (S106). When the brake fluid pressure does not fall in the non-brake-noise range (No in S106), the processing returns to S104 above. When the brake fluid pressure falls in the non-brake-noise range (Yes in S106), the gradient of the rate of reducing the brake fluid pressure is decreased. This allows for retaining the braking force to prevent abrupt acceleration.

In contrast, when the road surface gradient of the course of movement is graded (Yes in S102), a determination is made whether or not the road surface gradient of the course of movement is of a downhill (S108). When the road surface gradient of the course of movement is of a downhill (Yes in S108), the brake fluid pressure controller 19 estimates a brake-noise range (see range B in FIG. 13) (S109).

The estimation result is used to determine whether or not the brake fluid pressure falls in the brake-noise range (S110). When the brake fluid pressure falls in the brake-noise range (Yes in S110), a gradient of the brake fluid pressure as a change rate to increase or decrease the brake fluid pressure for exerting a braking force to a wheel is increased by a first predetermined amount, as compared with a case where the road surface gradient is not graded (S111). This allows for shortening duration of time within the brake-noise range as much as possible, when the vehicle travels on a downhill, to mitigate the influence from the brake noise.

When the brake fluid pressure does not fall in the brake-noise range (No in S110), a determination is made whether or not the brake fluid pressure falls in a no-brake-noise range (range A in FIG. 13) (S112). When the brake fluid pressure does not fall in a no-brake-noise range (No in S112), the processing returns to S110 above. When the brake fluid pressure falls in a no-brake-noise range (Yes in S112), the gradient of the rate of reducing the brake fluid pressure is decreased by a second predetermined amount, as compared with a case where the road surface gradient is not graded (S113). This allows for decreasing the gradient of the rate of reducing the brake fluid pressure in the no-brake-noise range (range A), when the vehicle 100 travels on a downhill, to retain the braking force for preventing an abrupt acceleration more reliably.

Likewise, when the road surface gradient of the course of movement is not of a downhill, that is, of an uphill (No in S108), the brake fluid pressure controller 19 estimates a brake-noise range (see range B in FIG. 13) (S114).

The estimation result is used to determine whether or not the brake fluid pressure falls in the brake-noise range (S115). When the brake fluid pressure falls in the brake-noise range (Yes in S115), a gradient of a rate of reducing the brake fluid pressure is increased by a third predetermined amount, as compared with a case where the road surface gradient is not graded (S116). This causes the gradient of the rate of reducing the brake fluid pressure to be increased by the third predetermined amount, because the vehicle 100 is less easily accelerated when traveling on an uphill, as compared with a case where the road surface gradient is not graded. This allows for shortening duration of time within the brake-noise range as much as possible to mitigate the influence from the brake noise.

When the brake fluid pressure does not fall in the brake-noise range (No in S115), a determination is made whether or not the brake fluid pressure falls in a no-brake-noise range (range A in FIG. 13) (S117). When the brake fluid pressure does not fall in a no-brake-noise range (No in S117), the processing returns to S115 above. When the brake fluid pressure falls in a no-brake-noise range (Yes in S117), the gradient of the rate of reducing the brake fluid pressure is decreased by a fourth predetermined amount, as compared with a case where the road surface gradient is not graded (S118). This causes the gradient of the rate of reducing the brake fluid pressure to be decreased by the fourth predetermined amount, because the vehicle 100 is less easily accelerated when traveling on an uphill, as compared with a case where the road surface gradient is not graded. This allows for decreasing the gradient of the rate of reducing the brake fluid pressure in the no-brake-noise range (range A), to retain the braking force.

As described above, the automated-parking control unit 1 (driving assist system) of the present embodiment for the vehicle 100 (see FIG. 1) includes: the environment recognizer 1a to recognize environment of the vehicle 100; the behavior controller 1b to execute behavior control inclusive of steering and acceleration/deceleration, based on recognized information; the brake hold instructor 13 to suspend the vehicle 100 with the behavior control and hold the suspension until receiving behavior-related operation by a driver; and the brake fluid pressure controller 19, when the vehicle is made to start moving forward or backward, to estimate a range having a brake noise and increase the change rate of the brake fluid pressure in a brake-noise range having a brake noise, as compared with that in a no-brake-noise range. The brake fluid pressure controller 19 estimates a range having a brake noise, when the vehicle is made to start moving forward or backward, and increases the gradient of the rate of reducing the brake fluid pressure in a brake-noise range having a brake noise (see range B in FIG. 13), as compared with that in a no-brake-noise range (see range A in FIG. 13).

With this configuration, in a case where the brake fluid pressure is transitioned from the no-brake-noise range (range C in FIG. 13), when the vehicle 100 is made to start moving forward or backward, via the brake-noise range (range B in FIG. 13) to the no-brake-noise range (range A in FIG. 13), the gradient of the rate of reducing the brake fluid pressure is increased in the brake-noise range (range B in FIG. 13) to promptly pass over the range in question. Duration of time within the brake-noise range is shortened as much as possible to mitigate the influence from the brake noise, while the gradient of the rate of reducing the brake fluid pressure is decreased in the no-brake-noise range (range A) to retain the braking force for preventing an abrupt acceleration. As a result, a braking noise of braking when the vehicle 100 is made to start moving forward or backward is prevented to eliminate uncomfortable feeling or discomfort due to a brake noise. This contributes to keeping quietness within the compartment, when the vehicle 100 is made to start moving forward or backward, to have advantageous effects of enhancing product appeal.

The vehicle 100 with the present embodiment includes the gradient sensor 26 to detect a gradient of a road surface on which the vehicle 100 is located, and the brake fluid pressure controller 19 varies the gradient of the rate of reducing the brake fluid pressure, based on a gradient of a course of movement. When the gradient is of a downhill, for example, the brake fluid pressure controller 19 decreases the gradient of the rate of reducing the brake fluid pressure in the non-brake-noise range, as compared with a case where the gradient is not graded, while increases the gradient of the rate of reducing the brake fluid pressure in the brake-noise range, as compared with a case where the road surface gradient is not graded. Likewise, when the gradient is of an uphill, the brake fluid pressure controller 19 increases the gradient of the rate of reducing the brake fluid pressure in the non-brake-noise range, as compared with a case where the gradient is not graded, while decreases the gradient of the rate of reducing the brake fluid pressure in the brake-noise range, as compared with a case where the gradient is not graded.

In this manner, the gradient of the rate of reducing the brake fluid pressure is varied, based on a gradient of a course of movement, and thus a brake noise is prevented while a braking force being exerted according to a gradient of a course of movement. When the road surface gradient of a course of movement is of a downhill, for example, the gradient of the rate of reducing the brake fluid pressure is increased by the first predetermined amount, as compared with a case where the road surface gradient is not graded, to shorten duration of time within the brake-noise range as much as possible for mitigating the influence from the brake noise. In addition, the gradient of the rate of reducing the brake fluid pressure is decreased by the second predetermined amount, as compared with a case where the road surface gradient is not graded, to decrease the gradient of the rate of reducing the brake fluid pressure in the no-brake-noise range (range A) to retain the braking force for preventing an abrupt acceleration more reliably.

The vehicle 100 with the present embodiment (see FIG. 1) has the brake fluid pressure controller 19 for brake fluid pressure control to increase a brake fluid pressure from a predetermined pressure to the desired brake fluid pressure. The desired brake fluid pressure is set to one with the brand-new brake pads as standards. That is, a brand-new brake pad includes a friction material having a larger thickness to easily make a brake noise. Once the desired brake fluid pressure is set to be used for increasing a brake fluid pressure with the brand-new brake pad as standards, a brake noise would be less likely made with a decreasing thickness of the friction material due to aging, to allow for preventing a brake noise regardless of aging of the disk brake 300.

The embodiment hereinabove has been described for the purpose of illustrating the present invention in detail, and is not limited to one having all the components as described above. The embodiment can be used in all cases to vary a gradient of a rate of reducing a brake fluid pressure, when causing a vehicle to start moving forward or backward, including not only a case to cause the vehicle to start moving forward but also a case to cause the vehicle to start moving backward. In addition, a case has been described above in which the embodiment is applied to the parking assist system as a driving assist system of a vehicle with self-driving capability, but the embodiment s not limited thereto and can be applied to a driving assist system in general.

### LIST OF REFERENCE SIGNS

1: automated-parking control unit (driving assist system), 1a: environment recognizer, 1b: behavior controller, 11: automated-parking controller (suspension hold controller), 11a: available parking position detector, 11b: desired parking position detector, 12: parking activation instruction detector, 13: brake hold instructor (suspension hold controller), 14: brake hold continuation determiner, 15: brake hold cancel instructor, 16: first parking operation interrupter, 17: second parking operation interrupter, 18: resume instructor, 19: brake fluid pressure controller, 25: shift position sensor, 26: gradient sensor (road surface gradient detector), 44: automated brake hold control unit (automated brake hold controller), 45: brake hold switch (cancel instruction controller), 64: shift lever, 72: steering wheel, 82: resume switch (resume instruction receiver), 100: vehicle, 202a: desired parking slot, 222: reverse steering position, 300: disk brake, 311: first brake pad, 312: second brake pad, A: no-brake-noise range, and B: brake-noise range.

What is claimed is:

1. A driving assist system comprising:
an environment recognizer to recognize environment of a vehicle;
a behavior controller to execute behavior control inclusive of steering and acceleration/deceleration, based on recognized information;
a suspension hold controller to suspend the vehicle with the behavior control and hold the vehicle suspended until receiving behavior-related operation by a driver; and
a brake fluid pressure controller to increase or decrease a braking fluid pressure as a braking force for a wheel,
wherein the brake fluid pressure controller,
when the vehicle is made to start moving forward or backward,
estimates a range having a brake noise and
increases a change rate of the brake fluid pressure in a brake-noise range having a brake noise, as compared with that in a no-brake-noise range.

2. The driving assist system as claimed in claim 1, further comprising:
a road surface gradient detector to detect a road surface gradient as a gradient of a road surface on which the vehicle is located, and
the brake fluid pressure controller varies the brake fluid pressure, based on the road surface gradient of a course of movement.

3. The driving assist system as claimed in claim 2, wherein
when the road surface gradient is of a downhill, the brake fluid pressure controller decreases the change rate of the brake fluid pressure in the non-brake-noise range, as compared with a case where the road surface gradient is not graded,
while increases the change rate of the brake fluid pressure in the brake-noise range, as compared with a case where the road surface gradient is not graded.

4. The driving assist system as claimed in claim 1, wherein
when the road surface gradient is of an uphill, the brake fluid pressure controller increases the change rate of the brake fluid pressure in the non-brake-noise range, as compared with a case where the road surface gradient is not graded,
while decreases the change rate of the brake fluid pressure in the brake-noise range, as compared with a case where the road surface gradient is not graded.

5. The driving assist system as claimed in claim 1, wherein
the brake fluid pressure controller executes brake fluid pressure control to decrease the brake fluid pressure from a predetermined pressure to a desired brake fluid pressure, and
the desired brake fluid pressure is set to one with brand-new brake pads as standards.

6. A vehicle with self-driving capability, the vehicle comprising:
an environment recognizer to recognize environment of a vehicle;
a behavior controller to execute behavior control inclusive of steering and acceleration/deceleration, based on recognized information;
a suspension hold controller to suspend the vehicle with the behavior control and hold the vehicle suspended until receiving behavior-related operation by a driver; and
a brake fluid pressure controller to increase or decrease a brake fluid pressure as a braking force for a wheel,
wherein the brake fluid pressure controller,
when the vehicle is made to start moving forward or backward,
estimates a range having a brake noise and
increases a change rate of the brake fluid pressure in a brake-noise range having a brake noise, as compared with that in a no-brake-noise range.

7. A driving assist method for a driving assist system including:
a environment recognizer to recognize environment of a vehicle;
a behavior controller to execute behavior control inclusive of steering and acceleration/deceleration, based on recognized information;
a suspension hold controller to suspend the vehicle with the behavior control and hold the vehicle suspended until receiving behavior-related operation by a driver; and
a brake fluid pressure controller to increase or decrease a braking fluid pressure as a braking force for a wheel,
the method comprising:
when the vehicle is made to start moving forward or backward,
estimating a range having a brake noise; and
increasing a change rate of the brake fluid pressure in a brake-noise range having a brake noise, as compared with that in a no-brake-noise range.

8. A non-transitory computer-readable storage medium storing a computer program for causing a computer to function as the driving assist system as claimed in claim 1.
